(19) United States
(12) Patent Application Publication
(10) Pub. No.: US 2019/0066177 A1
(43) Pub. Date: Feb. 28, 2019

(54) METHOD OF ORDERING A CUSTOM-MADE SUIT ONLINE

(71) Applicant: Austin Kim, Fresh Meadows, NY (US)

(72) Inventor: Austin Kim, Fresh Meadows, NY (US)

(21) Appl. No.: 15/687,690

(22) Filed: Aug. 28, 2017

(51) Int. Cl. G06Q 30/06; G06Q 20/10

(52) U.S. Cl. CPC G06Q 30/0621; G06Q 20/102; G06Q 30/0633

(57) ABSTRACT

Provided is a method of ordering a custom-made suit online, in which a user directly inputs user's body sizes or the sizes of the suit. The method of ordering a custom-made suit online includes connecting to a website in which a user orders a custom-made suit, inputting sizes of a user body or sizes of the custom-made suit, inputting user preferences for the custom-made suit, and reviewing and making a payment before transmitting the order.

### TECHNICAL FIELD

The present invention relates to a method of ordering a custom-made suit online, and more particularly, to a method of ordering a custom-made suit online where a user inputs user's body sizes or sizes of the custom-made suit.

### BACKGROUND OF THE DISCLOSURE

A custom-made suit can be ordered by a user and manufactured according to the user's preference and sizes. This is because every individual is unique in one's own sense, e.g., the way one carries, moves and communicates. Regardless of the same weight and height, no ones can get fit in the same clothes, and even if they do, the fitting would speak for itself why it would look different. Due to one's uniqueness and individuality, the custom-made suits are different from ones bought at a department store and provide the improved fit and details. The user looks better in clothing that is made just for him or her because custom tailoring takes into consideration the asymmetry of the wearer's body.

As industry advances, suit clothes having predetermined sizes and shapes are broadly commercialized. However, in recent years there is a trend to emphasize personal characteristics and thus, attention has been paid to a custom-made suit.

Typically, ordering a custom-made suit involves getting measured by a tailor, who then creates a pattern specific to a user's body. The tailor uses the pattern to cut the fabric and then sews the suit by hand, thereby making the custom tailoring referred to as a bespoke suit.

A conventional way to order the custom-made suit online replies on scanning a user's body to obtain the user's body sizes. However, the scanned data are limited in terms of reflecting the user's body sizes accurately, and therefore cause unoptimized fit and dissatisfaction to the user when the user wears a suit.

### SUMMARY OF THE DISCLOSURE

Disclosed is a method of ordering a custom-made suit online, in which a user directly inputs user's body sizes or the sizes of a custom-made suit. The method of ordering a custom-made suit online includes connecting to a web site in which a user orders a custom-made suit, inputting sizes of a user body or sizes of the custom-made suit, inputting user preferences for the custom-made suit, and reviewing and making a payment before transmitting the order.

The method may further comprise inputting user information including at least one of a name, an address, contact information, a destination address to which the custom-made suit is delivered, an occupation, a frequency of wearing a suit per a month, a frequency of purchasing a suit per a year, or total annual income.

The reviewing and making a payment may further include reviewing preferences and sizes to review and confirm the user preferences and sizes inputted during the inputting of user preferences and the inputting of sizes of a user body or sizes of the suit, respectively and making a payment to perform a payment for the custom-made suit.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flow chart illustrating a method of ordering a custom-made suit online according to an embodiment of the present invention;

FIG. 2 is a view illustrating pocket shapes according to an embodiment of the present invention;

FIG. 3 is a view illustrating lapel shapes according to an embodiment of the present invention;

FIG. 4 is a view illustrating patterns of a custom-made suit according to an embodiment of the present invention;

FIG. 5 is a view illustrating sizes of a top suit according to an embodiment of the present invention;

FIG. 6 is a view illustrating sizes of a bottom suit according to an embodiment of the present invention;

FIG. 7 is a flow chart illustrating a step of reviewing and making a payment according to an embodiment of the present invention; and

FIG. 8 is a flow chart illustrating a step of making a payment in more detail according to an embodiment of the present invention.

### DETAILED DESCRIPTION OF THE DISCLOSURE

Preferred embodiments of the present invention will be described in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, a method of ordering a custom-made suit online according to an embodiment of the present invention is described in greater detail.

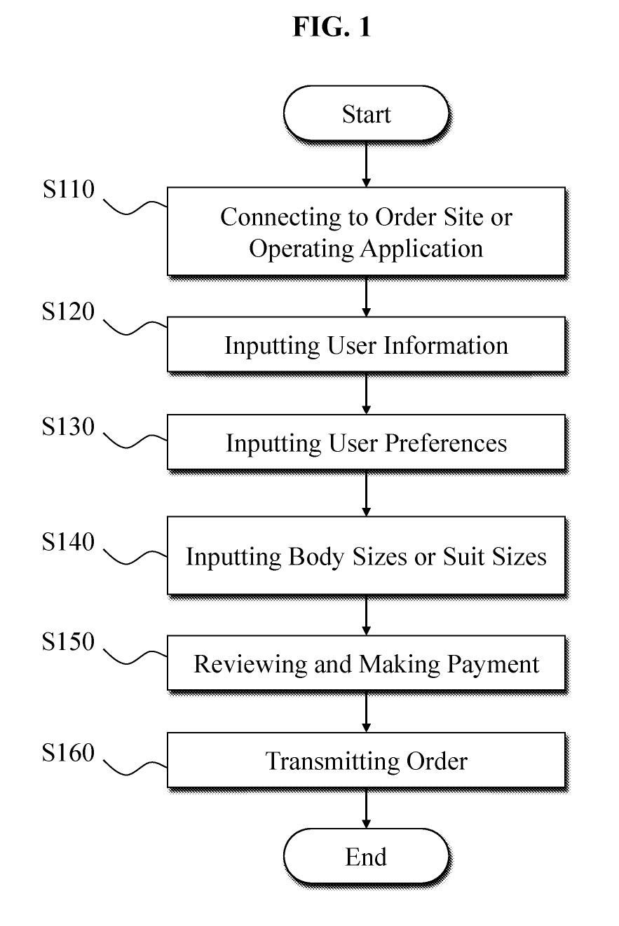

FIG. 1 is a flow chart illustrating the method of ordering a custom-made suit online according to an embodiment of the present invention. As shown in FIG. 1, a user may connect to a site in which the user orders the custom-made suit at step 110. Alternatively, the user may operate an application to begin the order process of the custom-made suit.

In general, the user opens a browser and inputs the address for a website, thereby connecting to the website in which the user can place an order for the custom-made suit. The website according to an embodiment of the present invention may be a website provided by a tailor or a manufacturer who makes the custom-made suit, or a site providing connection between the user and the tailor.

Alternatively, the user may operate an application to place an order of the custom-made suit from a smart terminal, such as a smart phone. The application may be able to allow the user to be connected to the order website through which the user can place an order of the custom-made suit. The application can be a form of being embedded in the smart terminal.

Hereinafter, it is described using a smart phone as an example of the smart terminal. However, the smart terminal is not limited thereto. The smart terminal according to an embodiment of the present invention may include a smart phone, a cellular phone, a phablet, a tablet, a laptop, a personal computer (PC), or a personal digital assistant (PDA), which can transmit an order online when the smart terminal is connected to the internet. For example, the smart terminal can include an electronic device having a memory, a microprocessor for executing, operating, and controlling a program.

Upon running the application or being connected to the website for ordering the custom-made suit, the user may be prompted to input user information at step S120. The user information includes a name, an address, and contact information. In order to input user information at this step, the user may choose to login in to the application or the website when the user has an account therein. Otherwise, the user may register and create an account to log in to the application or the website. When the user has an account therein, the user may store, in advance, the user information which is associated with the account. Thus, the user may avoid the inputting of user information.

The user information is not limited to those listed above, e.g., a name, an address, and contact information, but may be modified to include other information, such as an occupation, a frequency of wearing a suit per a month (e.g., days per month), a frequency of purchasing a suit per a year (e.g., suits per a year), total annual income, and others. The user information can be used to determine the best option for the user when the user orders the custom-made suit.

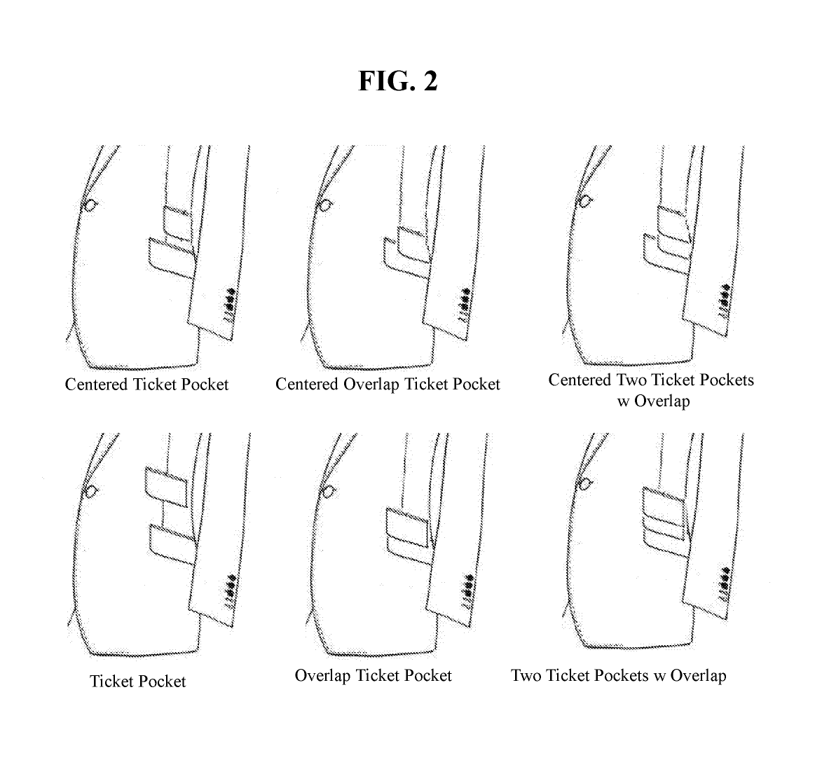

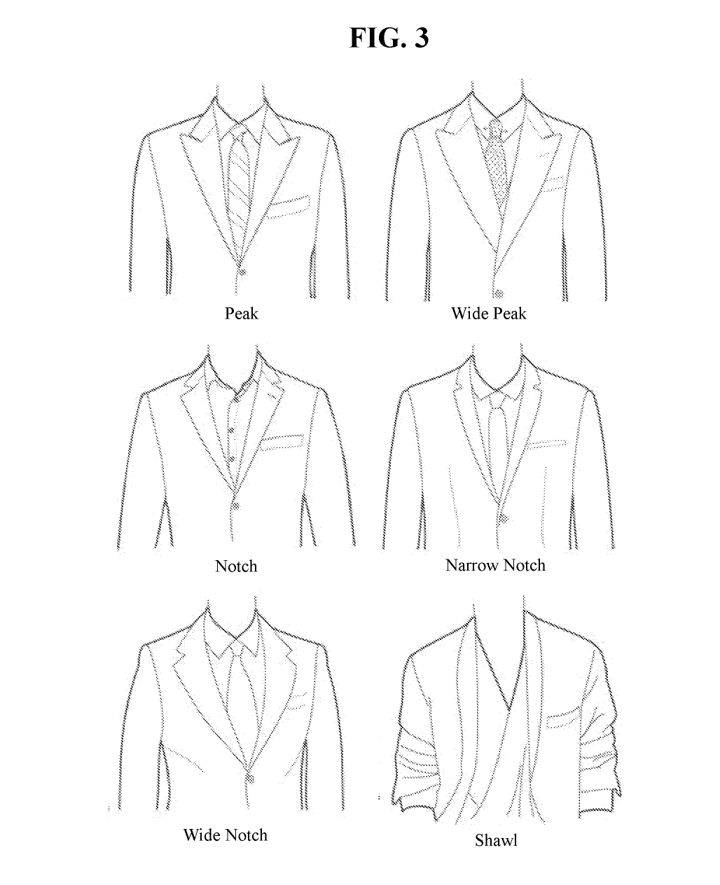

As shown in FIG. 1, the user is then prompted to input his or her preferences for the custom-made suit at step S130. The preferences for the custom-made suit include a color and style of the suit. The style further includes a collar shape, a sleeve shape, a lapel style, a pocket shape, the number of buttons, a button arrangement, or the type of closure. FIGS. 2 and 3 illustrate exemplary shapes of a pocket and a lapel according to an embodiment of the present invention. The lapel shape includes Peak, Wide Peak, Narrow Notch, or Shawl. In addition, the collar shape includes Saint Tropez, Hidden Button, Cut away, Button Down, Classic, Classic Narrow, Two Buttons Down, or Wing Up. The collar and pocket shapes are not limited to these lists herein, and can be modified to include other shapes.

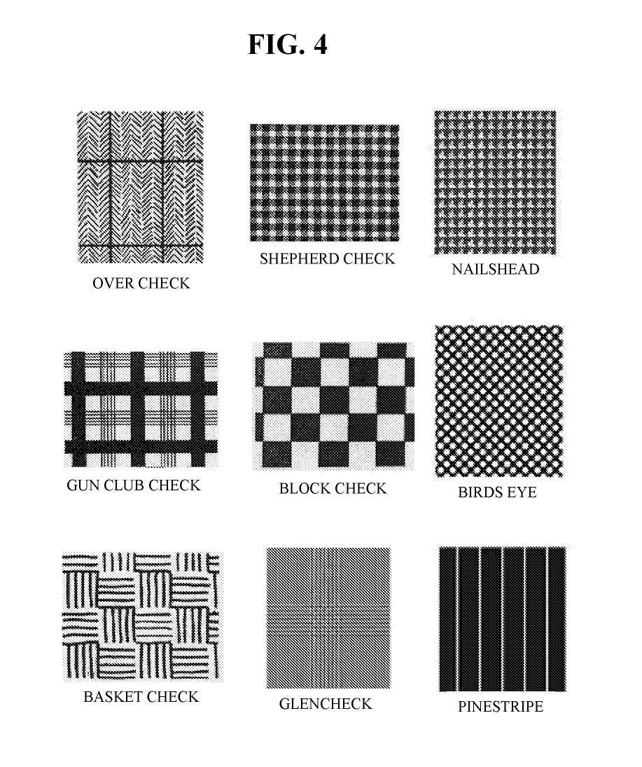

The user preferences at step S130 may further include a material or a pattern of the suit. FIG. 4 is a view illustrating exemplary patterns of the suit according to an embodiment of the present invention.

The user preferences may be pre-stored in the application or may be provided by the order website. For example, templates for the user preferences are provide and the user may be able to choose the pre-stored preferences, thereby maximizing the user convenience during the order process for the custom-made suit. In order to input the preferences, the user may be asked to choose one of the designs or styles from the pre-stored templates.

In addition, the step of inputting the preferences can be performed at the same time as the step of inputting the user information. Alternatively, the step of inputting the preferences can be performed after the input of user body sizes, which is described in detail below.

The user may also be asked to input body sizes at step 140, as shown in FIG. 1. Otherwise, the user may be asked to input the sizes of the suit at this step.

The sizes of a top suit include a chest circumference size, a belly circumference size, a shoulder size 11, an external arm length 12, an internal arm length 13, a neck circumference size, a cuff 14, or a total top length 15. The sizes of the top suit are not limited thereto.

The sizes of a bottom suit may include a waist circumference, a hip circumference, a hem size, an external leg length 21, an internal leg length 22, a total bottom length 23, a thigh size 24, or a calf size 25. The sizes of the top suit are not limited thereto.

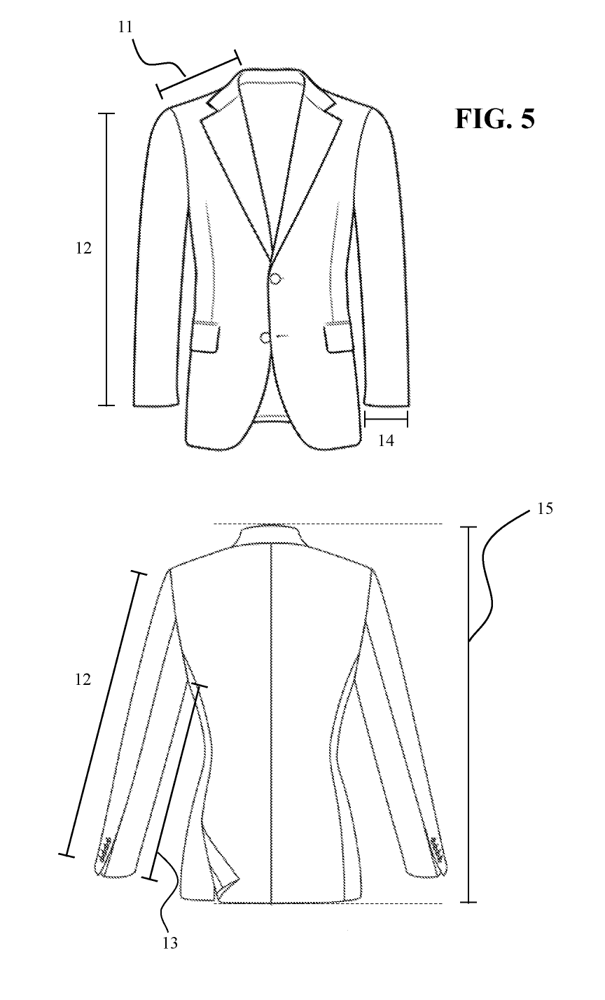

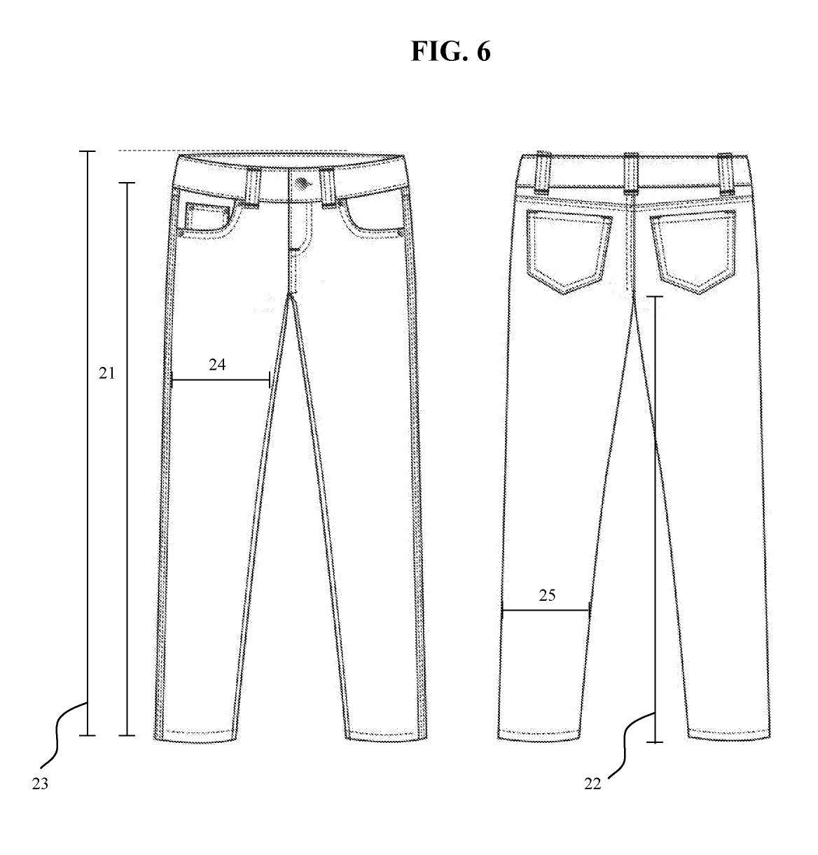

FIGS. 5 and 6 illustrate the sizes of a top suit and a bottom suit, respectively, according to an embodiment of the present invention.

The input of the user body sizes during the process of ordering a custom-made suit is advantageous in that the user can notify a tailor or a manufacturer of exact body sizes. Also, the changes of user body sizes can be promptly reported to the tailor or manufacturer of the custom-made suit, when there is a change in the body sizes during or after the input of body sizes.

For example, the user may want to change the sizes of specific parts of the suit, e.g., the chest size or belly size, due to the changes of the body sizes. Whenever the user needs to change the body sizes or the suit sizes, if the user should provide body scan data, it causes inconvenience. However, the user can connect to the site or the application and change the input values for the corresponding sizes, such that the changes in body sizes or suit sizes can be notified exactly and conveniently.

In addition, the input of the body sizes or suit sizes allows the tailor or the manufacturer to choose a best fit for the user, along with the information of the preferences inputted during the order process.

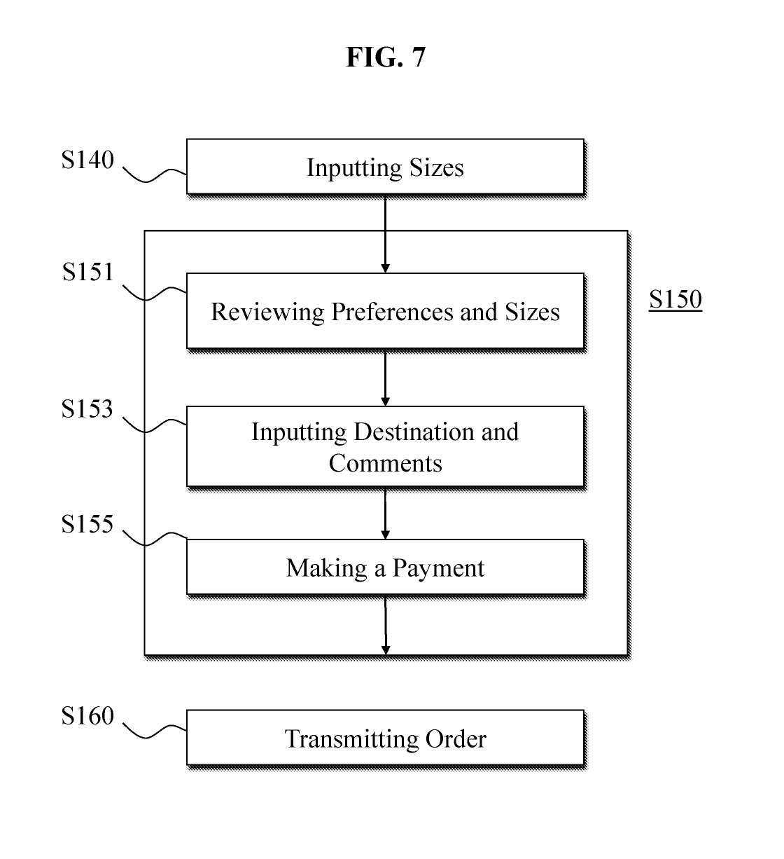

After the input of the body sizes or the suit sizes, the user moves to a step of reviewing and making a payment at step S150 prior to transmitting an order at step S160. FIG. 7 illustrates a process of reviewing and making a payment (step S150) in more detail according to an embodiment of the present invention. The reviewing and making a payment include a step of reviewing the styles or shapes the user chose during the order process and the body sizes inputted during the inputting of the body sizes (step S151). Further, the user may be given an opportunity to input a destination address where the custom-made suit will be delivered or other comments (step 153) during the reviewing and making a payment.

In addition, as shown in FIG. 7, the reviewing and making a payment may further include a step of determining a payment method and information (step S155) to thus perform the payment process for the custom-made suit,

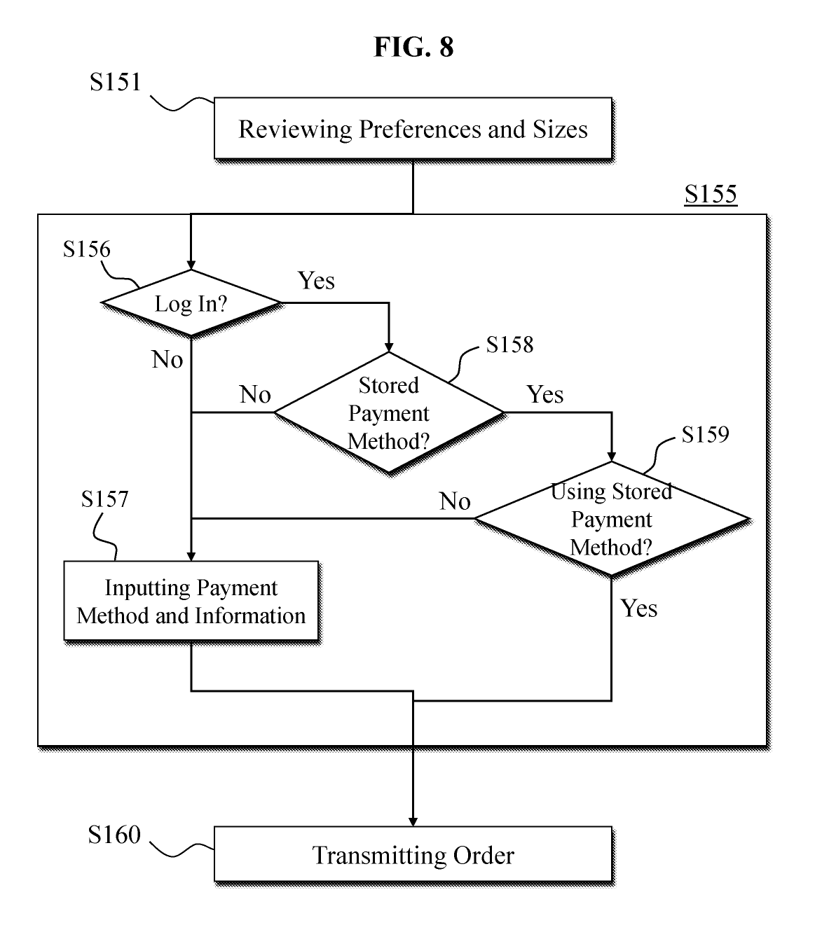

FIG. 8 illustrates the process of making a payment (step S155) according to an embodiment of the present invention. In order to perform the payment, it may be necessary to determine whether or not the user is logged in to the application or to the website (step S156). When the user did not log in to the application, the user is asked to input a payment method and payment information at step S157. However, if the user logged in to the application or the order site, it is determined whether there is a payment method and payment information stored in the user account (step S158). When there is the payment method and information previously stored and associated with the user account, it may be determined whether or not the user wants to use the stored payment method and information (step S159). In case that there was no payment method and information associated with the user account, or the user refused to use the stored payment method and information to perform the payment, the user moves to a step of inputting the payment method and information at step S157.

Exemplary payment method includes a credit card, a wiring, or a check. Corresponding payment information may be information for the credit card, e.g., a credit card number and effective date, information for conducting the wiring, such as bank information, a routing number, or an account number.

After the reviewing and making a payment, the user can transmit the order for the custom-made suit, and then may be given a confirmation page or a confirmation message in which the status of the order is displayed.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of ordering a custom-made suit online, the method comprising:
connecting to a website in which a user orders a custom-made suit;
inputting sizes of a user body or sizes of the custom-made suit;
inputting user preferences for the custom-made suit; and
reviewing and making a payment to review and make a payment for the custom-made suit.

2. The method of claim 1, further comprising:
inputting user information including at least one of a name, an address, contact information, a destination address to which the custom-made suit is delivered, an occupation, a frequency of wearing a suit per a month, a frequency of purchasing a suit per a year, or total annual income.

3. The method of claim 2, wherein the reviewing and making a payment further comprise:
reviewing preferences and sizes to review and confirm the user preferences and sizes inputted during the inputting of user preferences and the inputting of sizes of a user body or sizes of the suit, respectively; and
making a payment to perform a payment for the custom-made suit.

4. The method of claim 3, wherein the making a payment further comprises:
determining whether or not the user is logged in to the website;
inputting a payment method and payment information when the user does not log in to the website;
determining whether or not there is a payment method and payment information stored in a user account if the user logged in to the website; and
determining whether or not the user wants to use the stored payment method and information when there is the payment method and information stored in the user account.

5. The method of claim 4, wherein the sizes of a user body include at least one of a chest circumference size, a belly circumference size, a shoulder size, an external arm length, an internal arm length, a cuff, or a total top length.

6. The method of claim 5, wherein the sizes of a user body further include at least one of a waist circumference, a hip circumference, a hem size, an external leg length, an internal leg length, a total bottom length, a thigh size, or a calf size.

7. The method of claim 4, wherein the user preferences for the custom-made suit comprise at least one of a color, a collar shape, a sleeve shape, a lapel style, a pocket shape, the number of buttons, a button arrangement, a type of closure, a material of the suit, or a pattern of the suit.

8. A method of ordering a custom-made suit online, the method comprising:
operating an application through which a user orders a custom-made suit;
inputting sizes of a user body or sizes of the custom-made suit;
inputting user preferences for the custom-made suit; and
reviewing and making a payment to review and make a payment for the custom-made suit.

9. The method of claim 8, further comprising:
inputting user information including at least one of a name, an address, contact information, a destination address to which the custom-made suit is delivered, an occupation, a frequency of wearing a suit per a month, a frequency of purchasing a suit per a year, or total annual income.

10. The method of claim 9, wherein the reviewing and making a payment further comprise:
reviewing preferences and sizes to review and confirm the user preferences and sizes inputted during the inputting of user preferences and the inputting of sizes of a user body or sizes of the suit, respectively; and
making a payment to perform a payment for the custom-made suit.

11. The method of claim 10, wherein the making a payment further comprises:
determining whether or not the user is logged in to the application;
inputting a payment method and payment information when the user does not log in to the application;
determining whether or not there is a payment method and payment information stored in a user account if the user logged in to the application; and
determining whether or not the user wants to use the stored payment method and information when there is the payment method and information stored in the user account.

12. The method of claim 11, wherein the sizes of a user body include at least one of a chest circumference size, a belly circumference size, a shoulder size, an external arm length, an internal arm length, a cuff, or a total top length.

13. The method of claim 12, wherein the sizes of a user body further include at least one of a waist circumference, a hip circumference, a hem size, an external leg length, an internal leg length, a total bottom length, a thigh size, or a calf size.

14. The method of claim 11, wherein the user preferences for the custom-made suit comprise at least one of a color, a collar shape, a sleeve shape, a lapel style, a pocket shape, the number of buttons, a button arrangement, a type of closure, a material of the suit, or a pattern of the suit.
